(19) United States
(12) Patent Application Publication
(10) Pub. No.: US 2019/0289543 A1
(43) Pub. Date: Sep. 19, 2019

(54) SNIFF EARLY TERMINATION INDICATION TO REDUCE POWER CONSUMPTION FOR WIRELESS DEVICES

(71) Applicant: QUALCOMM Incorporated, San Diego, CA (US)

(72) Inventors: Balasubramani KANDASAMY, Hyderabad (IN); Sunit PUJARI, Hyderabad (IN); Tulasi Rama Durga Prasad KOLUSU, Hyderabad (IN); Venkata Phaneendra Reddy DUMPA, Visakhapatnam (IN)

(21) Appl. No.: 15/922,865

(22) Filed: Mar. 15, 2018

(51) Int. Cl. H04W 52/02; H04W 74/06; H04W 72/04; H04L 5/00

(52) U.S. Cl. CPC H04W 52/0216; H04W 52/0235; H04W 88/02; H04W 72/0446; H04L 5/0055; H04W 74/06

(57) ABSTRACT

The disclosure relates to techniques to extend the time that wireless devices spend in a sleep state. For example, a first wireless device may transmit a poll message to a second wireless device during a current polling period having multiple polling slots allocated to transmissions by the first wireless device. In response to receiving a null response message while there are one or more remaining polling slots allocated to transmissions by the first wireless device, the first wireless device may terminate the current polling period early. Furthermore, an early termination message may be transmitted to the second wireless device to indicate that the first wireless device will not be sending any further transmissions in the current polling period. As such, both wireless devices may then place one or more electronic circuits into a low-power mode prior to a sleep period scheduled to start when the current polling period ends.

### TECHNICAL FIELD

The various aspects and embodiments described herein relate to reducing power consumption in wireless communications, and more particularly, to early termination of a polling period to extend the time that a wireless device spends in a sleep state.

### BACKGROUND

Mobile and wireless technologies have seen explosive growth over the past several years. This growth has been fueled by better communications, hardware, and more reliable protocols. Wireless service providers are now able to offer their customers an ever-expanding array of features and services, and provide users with unprecedented levels of access to information, resources, and communications. To keep pace with these enhancements, mobile electronic devices (e.g., cellular phones, watches, headphones, remote controls, etc.) have become smaller, more powerful and more feature-rich than ever. Many of these devices now have impressive processing capabilities, large memories, and radios/circuitry for wirelessly sending and receiving information. Wireless communication technologies have also improved over the past several years. Wireless networks are now replacing wired networks in many homes and offices. Short-range wireless technologies, such as Bluetooth®, enable high speed communications between wireless electronic devices (e.g., mobile phones, watches, headphones, remote controls, etc.) that are within a relatively short distance of one another.

In particular, Bluetooth® wireless technology is a well-known and standardized short-range communications system intended to replace the cable(s) connecting portable and/or fixed electronic devices. Key features are robustness, low complexity, low power, and low cost. Bluetooth® devices are generally configured to send and receive data via a wireless radio link in the unlicensed 2.4 GHz ISM band and use frequency hopping to combat interference and fading. Bluetooth® protocols use a combination of circuit and packet switching. A slotted channel is used for exchanging information through packets. Slots can be used for asynchronous operation or can be reserved for synchronous packets. Bluetooth® systems can provide a point-to-point connection (only two Bluetooth® devices involved), or a point-to-multipoint connection. In the point-to-multipoint connection, the channel is shared among several Bluetooth® devices. Two or more devices sharing the same channel form a piconet. One Bluetooth® device acts as the master of the piconet, whereas the other device(s) acts as slave(s).

Bluetooth® is generally considered to be a secure protocol and is well-suited for short-range, low-power, low-cost wireless communication between electronic devices. Nonetheless, as with most battery operated technologies, power consumption is a major concern for Bluetooth® designers. One solution often used to conserve battery power is to put the electronic device into a sleep state, which generally refers to a state in which one or more electronic circuits (such as a receiver, a transmitter, a transceiver, etc.) are temporarily deactivated or put into a low-power consumption mode (e.g., back lighting off) to save battery energy. Accordingly, the Bluetooth® Core Specification has defined certain low-power modes to reduce power consumption (or extend battery life) and to free the piconet from device activity so that other devices may participate in the piconet. For example, Bluetooth® sleep modes include a sniff mode in which a slave device may periodically wake up at sniff anchor points to listen to transmissions from the master device and to re-synchronize a clock offset.

Because a device retains its active mode address while in sniff mode, sniff mode is commonly when no data transfer is happening at a given moment but active status is still needed (e.g., for human interface devices, between a handset and headset when not in an active call, for wearables or Internet of Things (IoT) devices that are expected to have a substantially continuous connection, etc.). However, because the slave device wakes up after each sniff interval to listen for transmissions from the master device, current is consumed for the duration that the slave device listens. As such, there may be a power savings opportunity in extending the time that a device spends in a sleep state such that the current consumption that occurs during sniff mode may be reduced.

### SUMMARY

The following presents a simplified summary relating to one or more aspects and/or embodiments disclosed herein. As such, the following summary should not be considered an extensive overview relating to all contemplated aspects and/or embodiments, nor should the following summary be regarded to identify key or critical elements relating to all contemplated aspects and/or embodiments or to delineate the scope associated with any particular aspect and/or embodiment. Accordingly, the following summary has the sole purpose to present certain concepts relating to one or more aspects and/or embodiments relating to the mechanisms disclosed herein in a simplified form to precede the detailed description presented below.

According to various aspects, a method for reducing power consumption for wireless devices may comprise transmitting, by a first wireless device, a poll message to a second wireless device during a polling slot in a current polling period having multiple polling slots that are allocated to transmissions by the first wireless device. In response to receiving, by the first wireless device, a null message acknowledging the transmitted poll message from the second wireless device, the first wireless device may terminate the current polling period early if the current polling period still has one or more remaining polling slots allocated to transmissions by the first wireless device when the null message is received. For example, terminating the current polling period early may comprise placing one or more electronic circuits into a low-power mode prior to a sleep period that is scheduled to start when the current polling period ends. Furthermore, in various implementations, the first wireless device may transmit, to the second wireless device, an early termination message to indicate that the first wireless device is terminating the current polling period early and no further transmissions from the first wireless device are pending in the current polling period, wherein the early termination message may comprise a command configured to cause the second wireless device to place one or more electronic circuits into a low-power mode prior to a sleep period that is scheduled to start when the current polling period ends.

According to various aspects, an apparatus may comprise a transmitter configured to transmit a poll message to a wireless device during a polling slot in a current polling period having multiple polling slots that are allocated to transmissions by the apparatus, a receiver configured to receive, from the wireless device, a null message acknowledging the transmitted poll message, and at least one processor configured to terminate the current polling period early in response to the current polling period having one or more remaining polling slots allocated to transmissions by the apparatus when the null message is received. In various implementations, the transmitter may be further configured to transmit, to the wireless device, an early termination message to indicate that the apparatus is terminating the current polling period early and no further transmissions from the apparatus are pending in the current polling period, wherein the early termination message may cause the wireless device to place one or more electronic circuits into a low-power mode prior to a sleep period scheduled to start when the current polling period ends.

According to various aspects, a method for reducing power consumption for wireless devices may comprise receiving, by a first wireless device, a poll message from a second wireless device during a polling slot in a current polling period, wherein the current polling period may have multiple polling slots that are allocated to transmissions by the second wireless device, transmitting, by the first wireless device, a null message to the second wireless device, wherein the null message acknowledges the poll message received from the second wireless device, and terminating, by the first wireless device, the current polling period early in response to receiving an early termination message from the second wireless device while the current polling period has one or more remaining polling slots allocated to transmissions by the second wireless device.

According to various aspects, an apparatus may comprise a receiver configured to receive a poll message from a wireless device during a polling slot in a current polling period having multiple polling slots that are allocated to transmissions by the wireless device, a transmitter configured to transmit a null message to the wireless device, the null message acknowledging the poll message received from the wireless device, and at least one processor configured to terminate the current polling period early in response to an early termination message received from the wireless device while the current polling period has one or more remaining polling slots allocated to transmissions by the wireless device.

Other objects and advantages associated with the aspects and embodiments disclosed herein will be apparent to those skilled in the art based on the accompanying drawings and detailed description.

### BRIEF DESCRIPTION OF THE DRAWINGS

A more complete appreciation of the various aspects and embodiments described herein and many attendant advantages thereof will be readily obtained as the same becomes better understood by reference to the following detailed description when considered in connection with the accompanying drawings which are presented solely for illustration and not limitation, and in which:

FIGS. 1A-1C illustrate exemplary personal area networks, or piconets, in which the various aspects and embodiments described herein can be suitably implemented.

FIG. 2 illustrates an example timing diagram corresponding to a sniff interval between a master device and a slave device, according to various aspects.

FIG. 3 illustrates an example timing diagram in which the master device enters a sleep state before a last polling slot in a polling period, according to various aspects.

FIG. 4 illustrates an example timing diagram in which the master device and the slave device both enter a sleep state before a last polling slot in a polling period, according to various aspects.

FIG. 5 illustrates an example method that a master device may perform to enter a sleep state before a last polling slot in a polling period based on one or more messages received from a slave device and to further cause the slave device to enter a sleep state before the last polling slot in the polling period, according to various aspects.

FIG. 6 illustrates an example method that a slave device may perform to enter a sleep state before a last polling slot in a polling period based on one or more messages received from a master device, according to various aspects.

FIG. 7 illustrates an exemplary electronic device that can be configured in accordance with the various aspects and embodiments described herein.

### DETAILED DESCRIPTION

Various aspects and embodiments are disclosed in the following description and related drawings to show specific examples relating to exemplary aspects and embodiments. Alternate aspects and embodiments will be apparent to those skilled in the pertinent art upon reading this disclosure, and may be constructed and practiced without departing from the scope or spirit of the disclosure. Additionally, well-known elements will not be described in detail or may be omitted so as to not obscure the relevant details of the aspects and embodiments disclosed herein.

The word “exemplary” is used herein to mean “serving as an example, instance, or illustration.” Any embodiment described herein as “exemplary” is not necessarily to be construed as preferred or advantageous over other embodiments. Likewise, the term “embodiments” does not require that all embodiments include the discussed feature, advantage, or mode of operation.

The terminology used herein describes particular embodiments only and should not be construed to limit any embodiments disclosed herein. As used herein, the singular forms “a,” “an,” and “the” are intended to include the plural forms as well, unless the context clearly indicates otherwise. Those skilled in the art will further understand that the terms “comprises,” “comprising,” “includes,” and/or “including,” as used herein, specify the presence of stated features, integers, steps, operations, elements, and/or components, but do not preclude the presence or addition of one or more other features, integers, steps, operations, elements, components, and/or groups thereof.

Further, various aspects and/or embodiments may be described in terms of sequences of actions to be performed by, for example, elements of a computing device. Those skilled in the art will recognize that various actions described herein can be performed by specific circuits (e.g., an application specific integrated circuit (ASIC)), by program instructions being executed by one or more processors, or by a combination of both. Additionally, these sequences of actions described herein can be considered to be embodied entirely within any form of non-transitory computer-readable medium having stored thereon a corresponding set of computer instructions that upon execution would cause an associated processor to perform the functionality described herein. Thus, the various aspects described herein may be embodied in a number of different forms, all of which have been contemplated to be within the scope of the claimed subject matter. In addition, for each of the aspects described herein, the corresponding form of any such aspects may be described herein as, for example, “logic configured to” and/or other structural components configured to perform the described action.

The term “Bluetooth®-enabled device” is used herein to refer to any electronic device that includes a radio frequency (RF) radio or RF transceiver and a processor or circuitry for implementing the Bluetooth® protocol stack/interface. Bluetooth® is an open standard for short-range radio frequency (RF) communications, details of which are set forth in the Bluetooth® Special Interest Group (SIG) Specification of the Bluetooth® System Version 5.0 published Dec. 6, 2016, which is publicly available and incorporated herein by reference in its entirety.

As mobile device and wireless technologies continue to improve and grow in popularity, there are many contemplated use cases in which short-range wireless technologies are expected to supplant or replace the need to connect devices together using cables or wires. As part of this evolution, it is becoming increasingly common to expect certain electronic devices such as wearables, Internet of Things (IoT) devices, and the like to have a substantially continuous (always-on) wireless connection. For example, any electronic device that includes a radio frequency (RF) radio and/or circuitry implementing a short wave wireless protocol/interface is a wireless-enabled device capable of communicating using short wave wireless technology. Such RF radios and circuitry are now being embedded in small electronic devices (e.g., headphone speakers, wearables, IoT devices, etc.), allowing these devices to communicate using wireless technology and replacing the need for wires or wire-based communications. However, such extensive use of RF radios may quickly deplete the battery of the electronic device and cause the entire electronic device to become unusable. This is particularly problematic for smaller electronic devices that have size, weight, and/or other limits that prevent them from including larger and more powerful batteries. As such, developing techniques to reduce power consumption and extend battery life and expected days of use (DOU) metrics is an important and challenging design criterion.

Accordingly, various aspects and embodiments described herein relate to certain power savings optimizations that can be used to extend or otherwise increase the time that electronic devices spend in a sleep state, which may advantageously extend battery life and the expected DOU that can be achieved before a battery needs to be recharged.

Furthermore, while the various aspects and embodiments described herein are particularly useful in mobile electronic devices that operate on battery power (e.g., mobile telephones, headsets, watches, wrist displays, laptops, etc.), the various aspects and embodiments described herein are generally useful in any electronic device that sends or receives information over a short-range wireless communication link. For example, reducing power consumption for a wall-plugged electronic device may be useful in developing energy-efficient systems, reducing utility bills, and so on.

Various aspects and embodiments are described herein using Bluetooth® and Bluetooth®-related terminology as a convenient example of a technology that can be used to wirelessly connect electronic devices located within a relatively short distance of one another (e.g., 100 meters). However, those skilled in the art will appreciate that examples referring to Bluetooth® and other references to Bluetooth® herein are for illustration purposes only and are not intended to limit the descriptions or the claims to that particular standard. Therefore, the scope of the claims should not be construed as requiring Bluetooth® technology unless specifically recited as such in the claims.

According to various aspects, Bluetooth® technology provides a secure way to connect and exchange information between electronic devices (e.g., headphones, cellular phones, watches, laptops, remote controls, etc.). Because many of the services offered over Bluetooth® can expose private data and/or allow the connecting party to control the connected device, Bluetooth® requires that devices first establish a “trust relationship” before they are allowed to connect to one another. This trust relationship may be established using a process called “pairing” in which a bond is formed between the two devices. This bond enables the devices to communicate with each other in the future without further authentication. The pairing process may be triggered by a specific request to create a bond (e.g., user explicitly requests to “add a Bluetooth® device”), or may be triggered automatically (e.g., when connecting to a service). For example, a Bluetooth® device may automatically initiate the performance of the pairing operations each time the device is powered or moved within a certain distance of another Bluetooth® device. Pairing information relating to current and previously established pairings may be stored in a paired device list (PDL) in the memory of the Bluetooth® device. This pairing information may include a name field, an address field, a link key field, and other similar fields (e.g., profile type, etc.) useful for authenticating the device and/or establishing a Bluetooth® communication link.

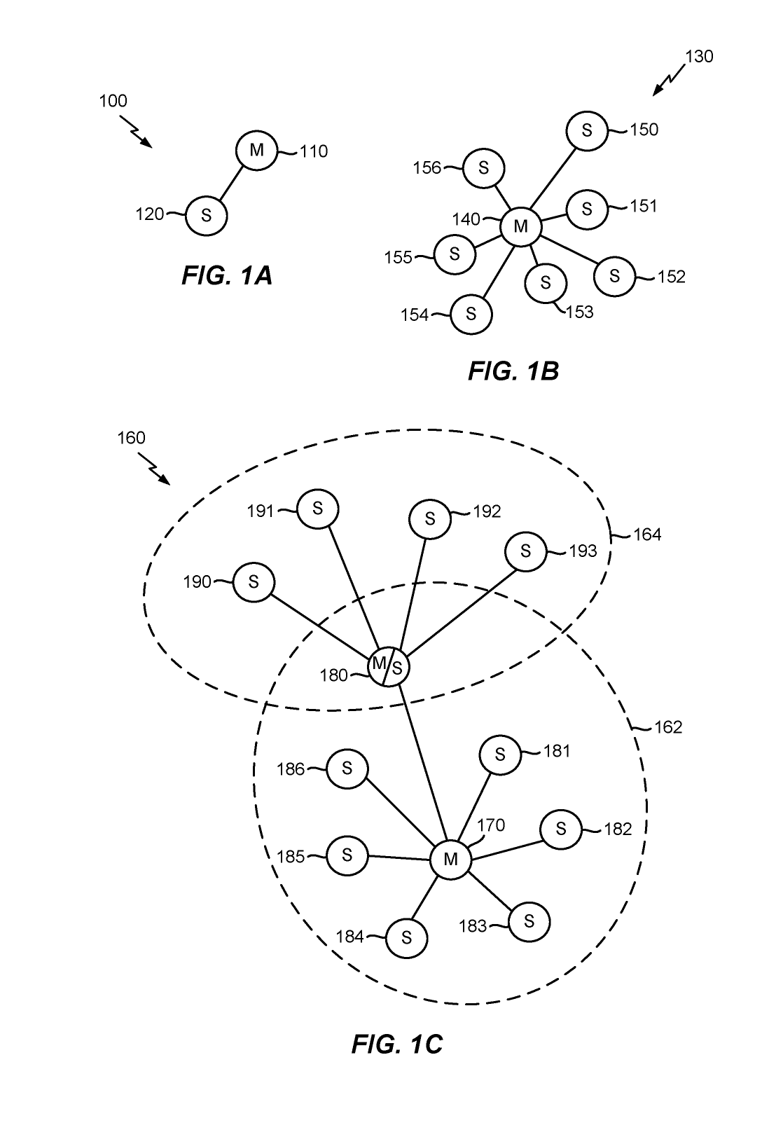

Bluetooth® communications may require establishing wireless personal area networks (also referred to as “ad hoc” or “peer-to-peer” networks), which are commonly called “piconets” in which a master-slave model is used to control when and where devices can send and receive data. In this model, a single master Bluetooth® device (referred to herein simply as the “master device”) can be connected with up to seven different active slave Bluetooth® devices (referred to herein simply as “slave devices”). A master device may only communicate with the slave devices that are within the same piconet as the master device. Slave devices may only communicate with the master device, and thus, communications between two or more slave devices are typically facilitated by the master device. For example, FIG. 1A illustrates an example piconet 100 in which a single master device 110 is connected to a single slave device 120 via a point-to-point connection. In another example, FIG. 1B illustrates a piconet 130 in which a single master device 140 is connected to seven slave devices 150-156 via a point-to-multipoint connection. Furthermore, in these and other examples, each device may belong to multiple piconets, including possible implementations in which a device may be a master in one piconet and a slave in another piconet, or the device may be a slave in multiple piconets. The former example is illustrated in FIG. 1C, which shows an exemplary scatternet 160 that includes multiple interconnected piconets 162, 164. The first piconet 162 includes a master device 170 connected to seven slave devices 180-186, including one slave device 180 that is also a master device connected to four slave devices 190-193 in the second piconet 164.

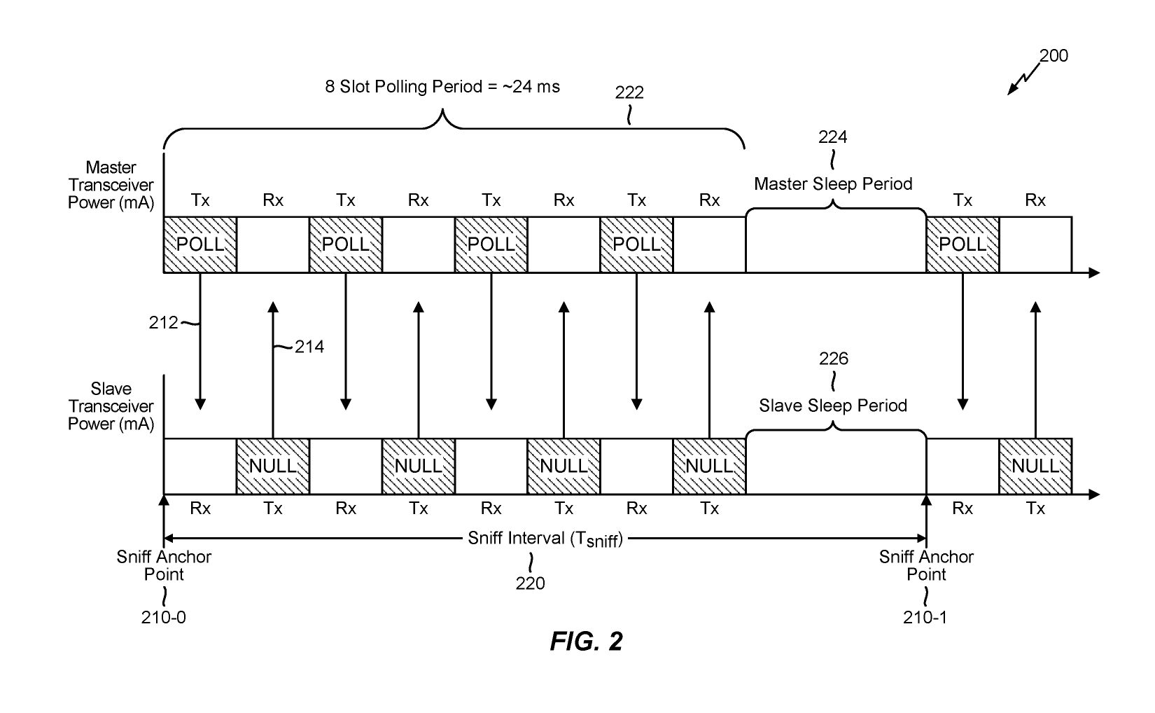

According to various aspects, when there is no active data transfer happening in a particular piconet (e.g., after an idle period lasting longer than a threshold duration), the master device and the connected slave device(s) may enter a low-power mode to save battery power or otherwise reduce power consumption. In the low-power mode, the master device and the slave device(s) may turn off a radio frequency (RF) transceiver and/or other suitable circuits and periodically awaken (e.g., turn on the RF transceiver) to synchronize a clock, check whether there is data to be transferred, verify that the connected devices are still present, etc. For example, FIG. 2 illustrates an example timing diagram 200 corresponding to a low-power mode in which a master device and a slave device may operate at a reduced duty cycle.

As illustrated in FIG. 2, the sniff mode may include various parameters, including a sniff interval (T_{sniff}) 220 and a number of sniff attempts, which may be chosen to satisfy data rate and latency requirements of the application, among other factors. For example, as shown in FIG. 2, the sniff mode parameters may specify sniff anchor points 210-0, 210-1 that are spaced regularly according to the sniff interval 220. At each sniff anchor point 210 (i.e., at the start of each sniff interval 220), there may be a polling period 222 including one or more specified time slots in which the master device can start transmission to the slave device. For example, as depicted at 212, the polling period 222 may include a time slot in which the master device sends a POLL packet to the slave device a given number of sniff attempts, which is generally a positive (non-zero) integer. The slave device in turn starts to listen (i.e., turns on its receiver) at the sniff anchor points 210-0, 210-1, etc. for a packet with a matching address. If the slave device has no data to send, the slave device replies with a NULL packet, as depicted at 214. The POLL and NULL packets exchanged between the master device and the slave device are similar in that each has a header with relevant device information, but neither has a payload. In contrast to the NULL packet, however, the POLL packet requires a confirmation from the recipient. Thus, the sniff mode may generally be described as the provision of periodic moments in time when communication from the master can occur, these times being spaced apart at longer intervals than available during normal operation.

In the standard Bluetooth® protocol, the polling period 222 can include multiple POLL/NULL exchanges between the master device and the slave device. For example, in FIG. 2, the polling period 222 includes eight (8) slots, including four master transmit (Tx) slots in which the master device transmits a POLL packet to the slave device and four master receive (Rx) slots in which the master device listens for a NULL response packet from the slave device. In a similar respect, the polling period 222 includes four slave receive (Rx) slots in which the slave device listens for a POLL packet from the master device and four slave transmit (Tx) slots in which the slave device transmits a NULL response packet to the master device. Assuming that each slot spans approximately three (3) milliseconds, the polling period 222 may last ˜24 ms. Furthermore, assuming that the sniff interval 220 used to space the sniff anchor points 210-0, 210-1, etc. is longer than −24 ms, the sniff interval 220 may include a master sleep period 224 and a slave sleep period 226 during which time the master device and the slave device can appropriately turn a transceiver off and/or place other suitable circuitry into a low-power (sleep) state until the next sniff anchor point 210.

Although the timing diagram 200 shown in FIG. 2 can reduce power consumption at the master device and the slave device because certain components can be turned off during the sleep periods 224, 226, there is still some current consumption (and thus power consumption) during the sniff mode because the master device and the slave device both need to have respective transceivers turned on during the polling period 222. In particular, both the master device and the slave device need to perform transmit and receive operations during the polling period 222, whereby the transceiver at each device needs to be in a fully active (ON) state during the polling period 222. As such, referring to FIG. 2, the x-axis represents time in terms of milliseconds (ms) and the y-axis represents peak current consumption in terms of milliamps (mA) when the master/slave transceiver is fully active. As such, assuming that X is the total time taken to perform the number of sniff attempts in the polling period 222 and Y is the peak current consumption when the master/slave transceiver is fully active, the total current consumption during each sniff interval 220 is XY msmA. The various aspects and embodiments described in further detail below may provide a mechanism to reduce transceiver activity during the polling period 222 and thereby extend the duration of one or more of the sleep periods 224, 226 such that the total current consumption during each sniff interval 220 can be reduced at the master and/or slave devices.

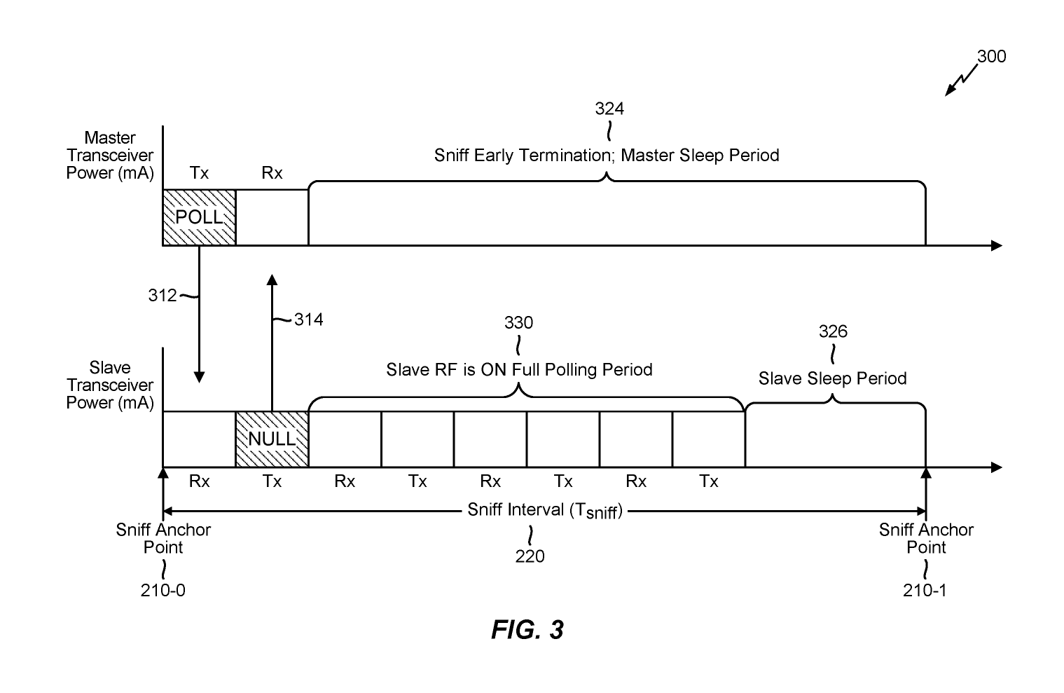

More particularly, according to various aspects, FIG. 3 illustrates an example timing diagram 300 in which the master device may enter a sleep state early (i.e., before a last polling slot in the polling period). For example, as depicted at 312, the master device may send a POLL packet to the slave device and the slave device may then send a NULL response packet to the master device at 314 in substantially the same manner as described above with respect to FIG. 2. However, once the master device receives the NULL response packet from the slave device, further sniff attempts may be unnecessary because the master device and the slave device have already confirmed that one another are present and responsive. As such, the master device may then terminate further sniff transmissions, turn a transceiver off, and enter an extended master sleep period 324, which may save substantial power at the master device because the current consumption attributable to the additional sniff attempts is eliminated. Furthermore, even if the master device does not receive a NULL response message from the slave device for some reason, the master device may still terminate further sniff attempts early if a suitable NULL response message is received from the slave device following a subsequent POLL message. However, even though the master device terminates the sniff transmissions early, the slave device continues to listen for subsequent POLL packets from the master device, as depicted at 330, before a sleep period 326 eventually starts after the full polling period is complete. This represents an additional unnecessary overhead at the slave device because the slave device has a transceiver turned on for the entire time period 330 during which the master device has stopped activity. For example, assuming that the sniff mode is configured with four POLL/NULL exchanges in eight slots as in FIG. 2 and the master device terminates further sniff attempts after the first attempt results in a NULL response message from the slave device, the slave device is unnecessarily keeping the transceiver on for 75% of the time slots.

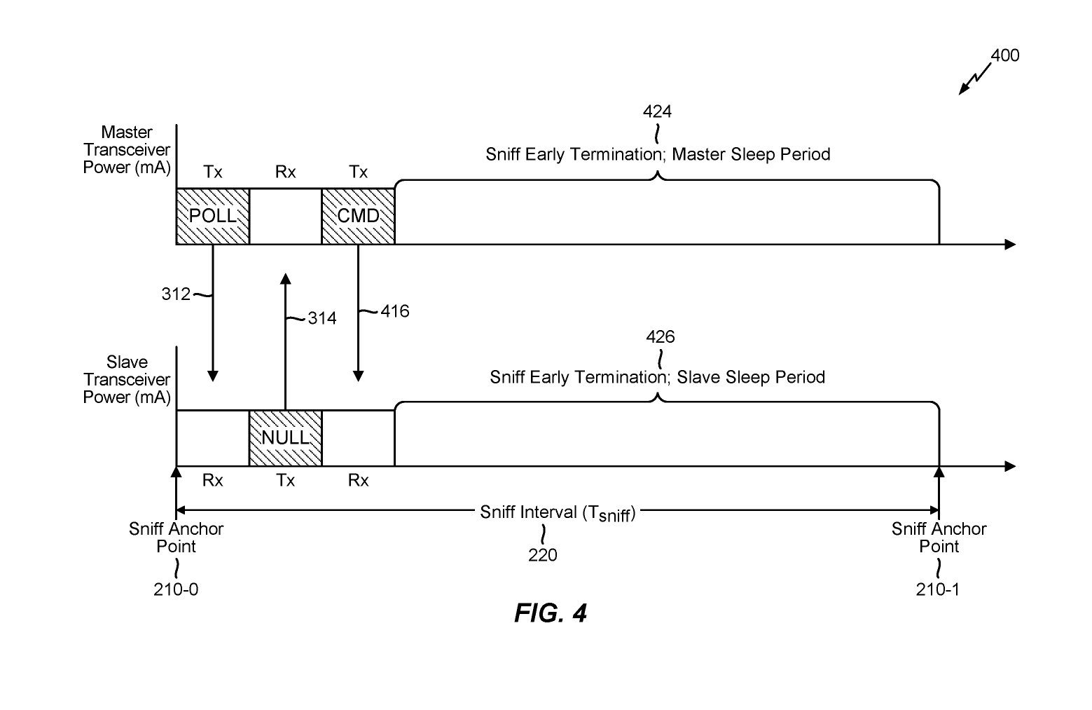

As such, according to various aspects, FIG. 4 illustrates another example timing diagram 400 in which the master device and the slave device may both enter a sleep state before the last polling slot in the polling period. In general, the timing diagram 400 as shown in FIG. 4 may be substantially similar to the timing diagram 300 shown in FIG. 3, wherein the master device terminates sniff transmissions early after the first NULL response message is received while one or more polling slots still remain in the current polling period. However, whereas FIG. 3 illustrates an example in which the master device immediately starts the sleep period 324 after the first NULL response message is received, in FIG. 4 the master device sends a command to the slave device to indicate that the master device will be terminating further sniff transmissions early, as depicted at 416. In various embodiments, the master device and the slave device may exchange capability information when determining the sniff mode parameters, wherein the exchanged capability information may indicate whether the master device and/or the slave device can perform sniff early termination. For example, in various embodiments, the master device may request or read a hardware identifier or other suitable data from the slave device, which may indicate whether the slave device can perform sniff early termination. In the event that the slave device can perform sniff early termination, the master device may send the early termination command to the slave device at 416 (e.g., as an action frame using a vendor command), wherein the early termination command may indicate that the master device will cease further activity and not send any further POLL transmissions during the current polling period. The master device may then start the master sleep period, as depicted at 424, and the slave device may similarly terminate further activity for the remaining slots in the polling period and start the slave sleep period early after receiving the early termination command, as depicted at 426.

As such, assuming an 8-slot sniff interval as shown in FIG. 2, early termination following a successful POLL/NULL exchange in the first two slots means that the master device and the slave device can turn off a transceiver (and/or other electronic circuits) after only three Tx/Rx slots such that the sleep periods 424, 426 are extended an additional five slots, resulting in a 62.5% power savings. Furthermore, even if the slave device does not acknowledge the first POLL message, the master device and the slave device may still start the sleep periods 424, 426 early where there is a successful POLL/NULL exchange in the subsequent two slots followed by an early termination command in the fifth slot. In this case, the sleep periods 424, 426 would still be extended an additional three out of eight slots, resulting in a 37.5% power savings. As such, any early termination that occurs while there are one or more remaining polling slots in a current polling period may advantageously reduce power consumption at both the master device and the slave device.

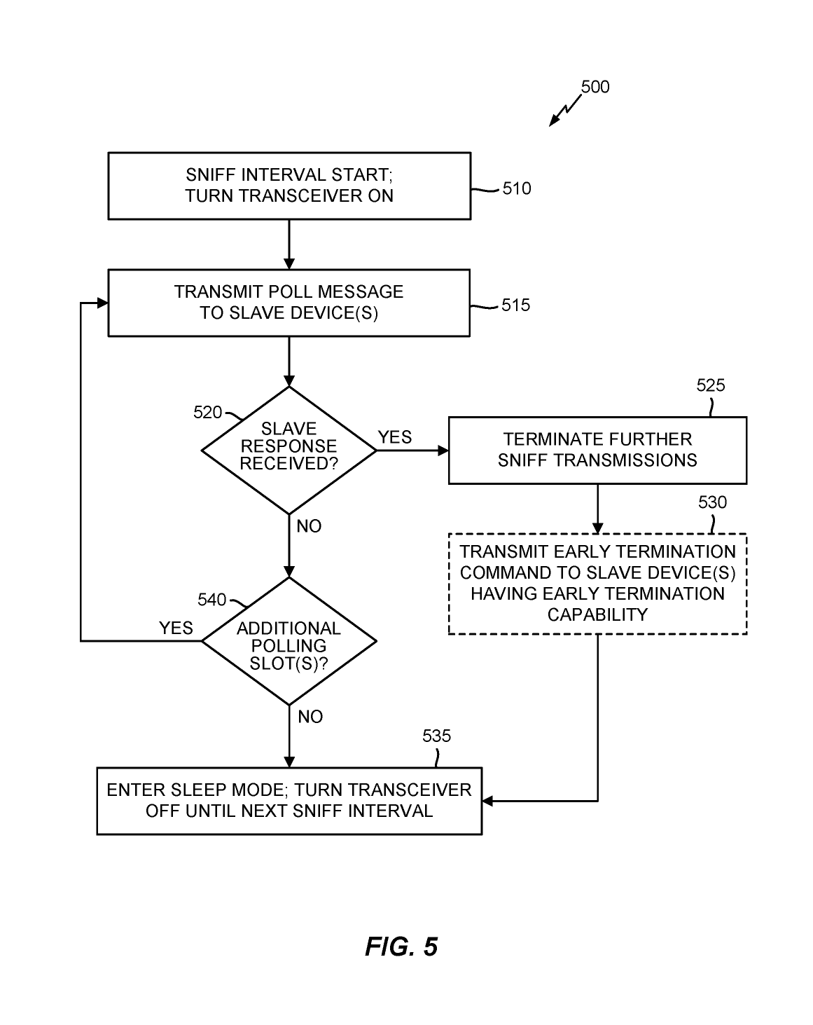

According to various aspects, FIG. 5 illustrates an example method 500 that a master device may perform to enter a sleep state before a last polling slot in a polling period based on one or more messages received from a slave device. More particularly, the method 500 may generally represent operations that are performed during a given sniff interval such that the master device and the slave device can be assumed to have already exchanged sufficient information to establish an agreed-upon sniff interval, sniff anchor points, sniff attempts (or polling slots) per sniff interval, and/or other suitable sniff mode parameters. Furthermore, the master device and the slave device may have exchanged certain capability information, including information that indicates whether the master device and/or the slave device can perform sniff early termination when a successful POLL/NULL exchange is completed while one or more sniff attempts remain in the current sniff interval.

Accordingly, at block 510, a current sniff interval may start and the master device may turn on a transceiver and/or any other electronic circuits that may be in a sleep state or other low-power mode (e.g., during a sleep period in a prior sniff interval). In various embodiments, at block 515, the master device may then transmit a POLL message to the connected slave device(s) during a transmit (Tx) slot allocated to POLL transmissions from the master device. The master device may then listen for a NULL response message from the slave device(s) as an acknowledgement of the POLL message to confirm presence of the slave device(s). Accordingly, at block 520, the master device may determine whether a NULL response was received from a given slave device during a receive slot allocated to transmission of the NULL response from the slave device. In response to determining that a NULL response was received, the master device may terminate further sniff transmissions at block 525. Furthermore, at block 530, the master device may optionally further transmit an early termination command to any slave device(s) having a sniff early termination capability (e.g., as determined from the previously exchanged capability information). In various embodiments, at block 535, the master device may then enter sleep mode, turning off the transceiver and/or otherwise placing one or more electronic circuits into a low-power mode until a next sniff interval.

According to various aspects, returning to block 520, the master device may determine whether there are one or more additional polling slots in the current polling period at block 540 in the event that a NULL response was not received from the slave device during the receive slot allocated to transmission of the NULL response. In response to determining that there are no more polling slots in the current polling period, the master device may enter sleep mode at block 535 in a conventional manner. However, if there are one or more additional polling slots in the current polling period, the method 500 may loop back to block 515 and proceed in substantially the same manner as described above. Accordingly, as mentioned above, there may be additional opportunities to terminate sniff activity early and thereby extend the time spent in sleep mode as long as a NULL response acknowledging a POLL message is received while there are additional polling slots remaining in the current polling period.

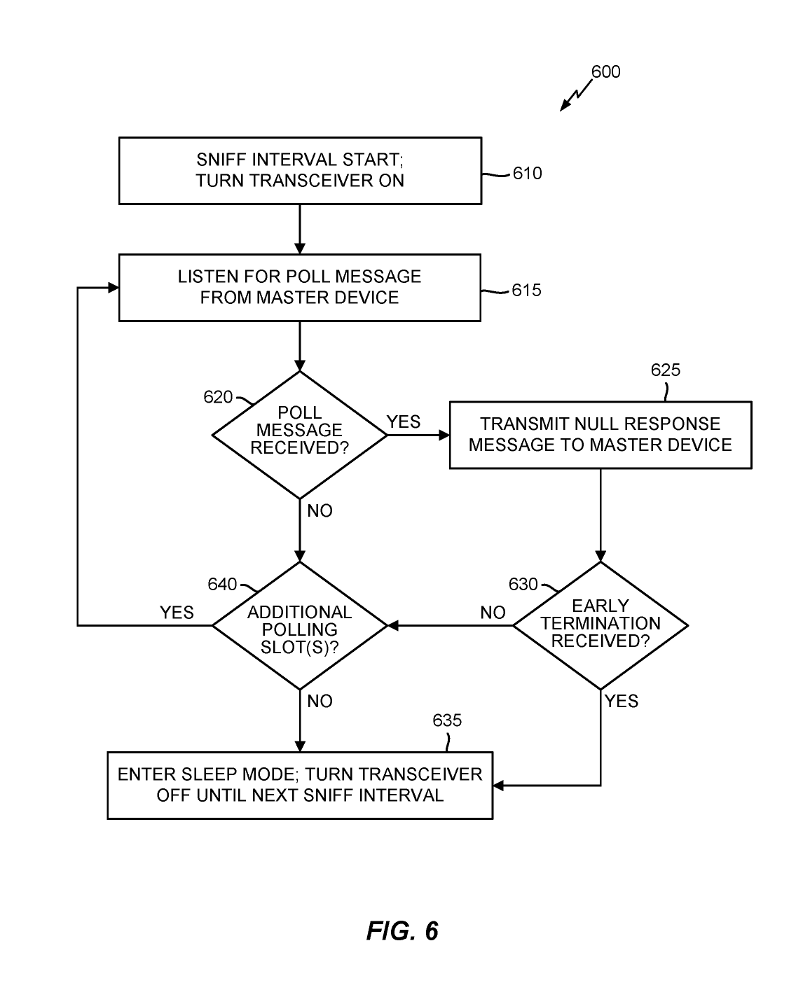

According to various aspects, FIG. 6 illustrates an example method 600 that a slave device may perform to enter a sleep state before a last polling slot in a polling period based on one or more messages received from a master device. More particularly, the method 600 shown in FIG. 6 may generally represent operations that the slave device performs during a given sniff interval such that the master device and the slave device can be assumed to have already exchanged sufficient information to establish an agreed-upon sniff interval, sniff anchor points, sniff attempts (or polling slots) per sniff interval, and/or other suitable sniff mode parameters. Furthermore, the master device and the slave device may have exchanged certain capability information, including information that indicates whether the master device and/or the slave device can perform sniff early termination when a successful POLL/NULL exchange is completed while one or more sniff attempts remain in the current sniff interval. Furthermore, those skilled in the art will appreciate that the operations shown in FIG. 5 and FIG. 6 generally represent counterpart operations that the master device and the slave device are configured to perform in a given sniff interval.

Accordingly, at block 610, a current sniff interval may start (e.g., at a sniff anchor point) and the slave device may turn on a transceiver and/or any other electronic circuits that may be in a sleep state or other low-power mode. In various embodiments, at block 615, the slave device may then listen for a POLL message that the master device is configured to transmit during a receive (Rx) slot at the slave device. Accordingly, at block 620, the slave device may determine whether a POLL message was received from the master device during the Rx slot, in which case the slave device may subsequently transmit a NULL response message to the master device at block 625 during a transmit (Tx) slot allocated to the NULL response message transmission. As noted above, when the slave device transmits the NULL response message while there are one or more remaining polling slots in the current polling period, the master device may decide to terminate the polling period early. As such, at block 630, the slave device may determine whether an early termination message was received from the master device during a next Rx slot that would otherwise be allocated to a POLL transmission from the master device. In response to receiving such an early termination message from the master device, the slave device may enter sleep mode at block 635, meaning that the slave device may turn off the transceiver and/or otherwise place one or more electronic circuits into a low-power mode until a next sniff interval because the early termination message indicates that the master device will not be sending any further transmissions during the current polling period/sniff interval.

According to various aspects, returning to block 620 and block 630, the slave device may determine whether there are one or more additional polling slots in the current polling period at block 640 in the event that a POLL response was not received from the master device or alternatively in the event that an early termination message was not received from the master device following the NULL response message transmission. In response to determining that there are no more polling slots in the current polling period, the slave device may enter sleep mode at block 635 in a conventional manner. However, if there are one or more additional polling slots in the current polling period, the method 600 may loop back to block 615 and proceed in substantially the same manner as described above. Accordingly, as mentioned above, there may be additional opportunities to terminate sniff activity early and thereby extend the time spent in sleep mode as long as an early termination message is received following a NULL response message that the slave device transmits to acknowledge a POLL message while additional polling slots remain in the current polling period.

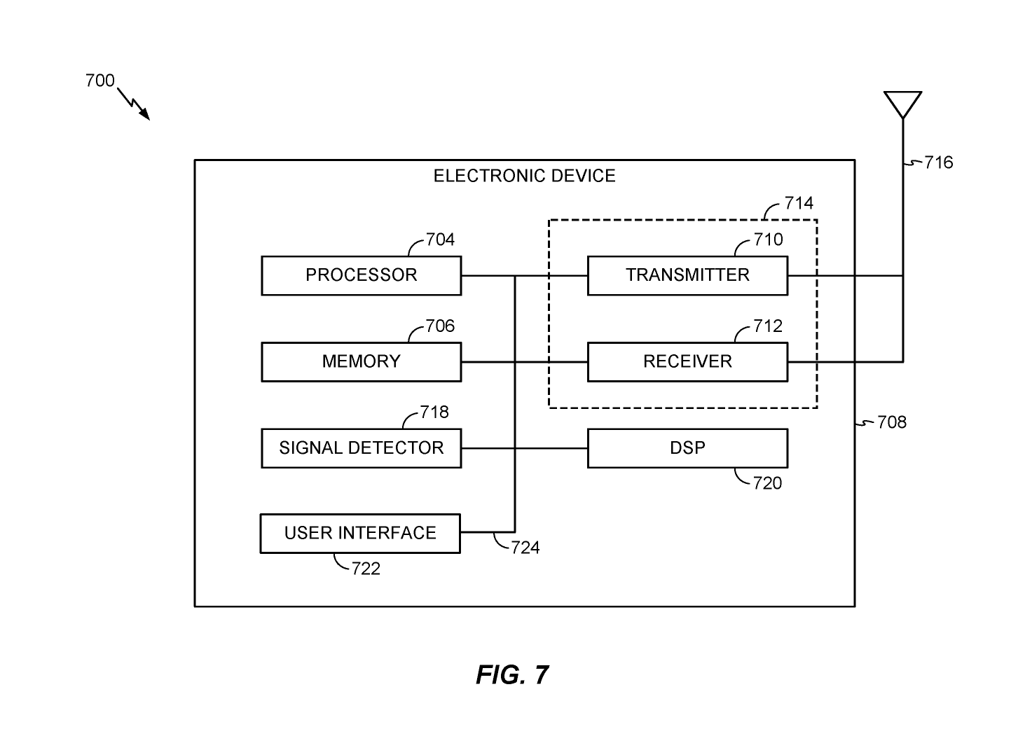

According to various aspects, FIG. 7 illustrates an exemplary electronic device 700 that can be configured in accordance with the various aspects and embodiments described herein. For example, the electronic device 700 may correspond to a master device that can transmit an early termination command to a slave device when the slave device appropriately responds to a polling message while there are one or more remaining polling slots in a current polling period, wherein the early termination command may indicate that the master device will send no further polling messages during the current polling period such that the slave device can turn off a transceiver and enter a sleep state until a next polling period during a next sniff interval. Alternatively and/or additionally, the electronic device 700 may be a slave device that can receive the above-mentioned early termination command from a master device and then turn off a transceiver and enter a sleep state until the next sniff interval begins. Furthermore, as noted above, in some cases a given device may be a master device in one piconet and a slave device in another piconet, whereby the electronic device 700 can appropriately correspond to both a master device and a slave device depending on context.

In various embodiments, the electronic device 700 can include a processor 704, a memory 706, a housing 708, a transmitter 710, a receiver 712, an antenna 716, a signal detector 718, a digital signal processor (DSP) 720, a user interface 722, and a bus system 724. Alternatively, the functions of the transmitter 710 and the receiver 712 can be incorporated into a transceiver 714. The electronic device 700 can be configured to communicate in a wireless network that includes, for example, a base station (not illustrated), an access point (not illustrated), and the like.

In various embodiments, the processor 704 can be configured to control operations of the electronic device 700. The processor 704 can also be referred to as a central processing unit (CPU). The memory 706 can be coupled to the processor 704, can be in communication with the processor 704, and can provide instructions and data to the processor 704. The processor 704 can perform logical and arithmetic operations based on program instructions stored within the memory 706. The instructions in the memory 706 can be executable to perform one or more of the methods and processes described herein. In various embodiments, the processor 704 can include, or be a component of, a processing system implemented with one or more processors. The one or more processors can be implemented with any combination of general-purpose microprocessors, microcontrollers, digital signal processors (DSPs), field programmable gate array (FPGAs), programmable logic devices (PLDs), controllers, state machines, gated logic, discrete hardware components, dedicated hardware finite state machines, or any other suitable entities that can perform calculations and/or manipulate information. The processing system can also include machine-readable media for storing software. Software can be construed broadly to mean any type of instructions, whether referred to as software, firmware, middleware, microcode, hardware description language, or otherwise. Instructions can include code, e.g., in source code format, binary code format, executable code format, or any other suitable format of code. The instructions, when executed by the one or more processors, can cause the processing system to perform one or more of the functions described herein.

In various embodiments, the memory 706 can include both read-only memory (ROM) and random access memory (RAM). A portion of the memory 706 can also include non-volatile random access memory (NVRAM).

In various embodiments, the transmitter 710 and the receiver 712 (or the transceiver 714) can allow transmission and reception of data between the electronic device 700 and a remote location. The antenna 716 can be attached to the housing 708 and electrically coupled to the transceiver 714. In some implementations, the electronic device 700 can also include multiple transmitters, multiple receivers, multiple transceivers, and/or multiple antennas (not illustrated).

In various embodiments, the signal detector 718 can be used to detect and quantify the level of signals received by the transceiver 714. The signal detector 718 can detect such signals as total energy, energy per subcarrier per symbol, and/or power spectral density and in other ways.

In various embodiments, the digital signal processor (DSP) 720 can be used to process signals. The DSP 720 can be configured to generate a packet for transmission. In some aspects, the packet can include a physical layer protocol data unit (PPDU).

In various embodiments, the user interface 722 can include, for example, a keypad, a microphone, a speaker, and/or a display. The user interface 722 can include any element or component that conveys information to a user of the electronic device 700 and/or receives input from a user.

In various embodiments, the various components of the electronic device 700 can be coupled together by a bus system 724. The bus system 724 can include a data bus, and can also include a power bus, a control signal bus, and/or a status signal bus in addition to the data bus.

In various embodiments, the electronic device 700 can also include other components or elements not illustrated in FIG. 7. One or more of the components of the electronic device 700 can be in communication with another one or more components of the electronic device 700 by means of another communication channel (not illustrated) to provide, for example, an input signal to the other component.

Although a number of separate components are illustrated in FIG. 7, one or more of the components can be combined or commonly implemented. For example, the processor 704 and the memory 706 can be embodied on a single chip. The processor 704 can additionally, or in the alternative, contain memory, such as processor registers. Similarly, one or more of the functional blocks or portions of the functionality of various blocks can be embodied on a single chip. Alternatively, the functionality of a particular block can be implemented on two or more chips. For example, the processor 704 can be used to implement not only the functionality described above with respect to the processor 704, but also to implement the functionality described above with respect to the signal detector 718 and/or the DSP 720.

Those skilled in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those skilled in the art will appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted to depart from the scope of the various aspects and embodiments described herein.

The various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices (e.g., a combination of a DSP and a microprocessor, a plurality of microprocessors, one or more microprocessors in conjunction with a DSP core, or other such configurations).

The methods, sequences, and/or algorithms described in connection with the aspects disclosed herein may be embodied directly in hardware, in a software module executed by a processor, or in a combination of the two. A software module may reside in RAM, flash memory, ROM, EPROM, EEPROM, registers, hard disk, a removable disk, a CD-ROM, or any other form of non-transitory computer-readable medium known in the art. An exemplary non-transitory computer-readable medium may be coupled to the processor such that the processor can read information from, and write information to, the non-transitory computer-readable medium. In the alternative, the non-transitory computer-readable medium may be integral to the processor. The processor and the non-transitory computer-readable medium may reside in an ASIC. The ASIC may reside in an IoT device. In the alternative, the processor and the non-transitory computer-readable medium may be discrete components in a user terminal.

In one or more exemplary aspects, the functions described herein may be implemented in hardware, software, firmware, or any combination thereof. If implemented in software, the functions may be stored on or transmitted over as one or more instructions or code on a non-transitory computer-readable medium. Computer-readable media may include storage media and/or communication media including any non-transitory medium that may facilitate transferring a computer program from one place to another. A storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Also, any connection is properly termed a computer-readable medium. For example, if the software is transmitted from a website, server, or other remote source using a coaxial cable, fiber optic cable, twisted pair, DSL, or wireless technologies such as infrared, radio, and microwave, then the coaxial cable, fiber optic cable, twisted pair, DSL, or wireless technologies such as infrared, radio, and microwave are included in the definition of a medium. The term disk and disc, which may be used interchangeably herein, includes CD, laser disc, optical disc, DVD, floppy disk, and Blu-ray discs, which usually reproduce data magnetically and/or optically with lasers. Combinations of the above should also be included within the scope of computer-readable media.

While the foregoing disclosure shows illustrative aspects and embodiments, those skilled in the art will appreciate that various changes and modifications could be made herein without departing from the scope of the disclosure as defined by the appended claims. Furthermore, in accordance with the various illustrative aspects and embodiments described herein, those skilled in the art will appreciate that the functions, steps, and/or actions in any methods described above and/or recited in any method claims appended hereto need not be performed in any particular order. Further still, to the extent that any elements are described above or recited in the appended claims in a singular form, those skilled in the art will appreciate that singular form(s) contemplate the plural as well unless limitation to the singular form(s) is explicitly stated.

What is claimed is:

1. A method for reducing power consumption for wireless devices, comprising:
transmitting, by a first wireless device, a poll message to a second wireless device during a polling slot in a current polling period, the current polling period having multiple polling slots that are allocated to transmissions by the first wireless device;
receiving, by the first wireless device, a null message acknowledging the transmitted poll message from the second wireless device; and
terminating, by the first wireless device, the current polling period early in response to the current polling period having one or more remaining polling slots allocated to transmissions by the first wireless device when the null message is received.

2. The method recited in claim 1, further comprising transmitting, to the second wireless device, an early termination message to indicate that the first wireless device is terminating the current polling period early and no further transmissions from the first wireless device are pending in the current polling period.

3. The method recited in claim 2, wherein the early termination message comprises a command configured to cause the second wireless device to place one or more electronic circuits into a low-power mode prior to a sleep period that is scheduled to start when the current polling period ends.

4. The method recited in claim 2, further comprising receiving, from the second wireless device, capability information indicating whether the second wireless device has an ability to terminate the current polling period early.

5. The method recited in claim 4, wherein the first wireless device is configured to transmit the early termination message to the second wireless device in response to the received capability information indicating that the second wireless device has the ability to terminate the current polling period early.

6. The method recited in claim 1, wherein terminating the current polling period early comprises placing one or more electronic circuits into a low-power mode prior to a sleep period that is scheduled to start when the current polling period ends.

7. The method recited in claim 6, wherein the one or more electronic circuits include a radio frequency transceiver configured to transmit the poll message to the second wireless device and to receive the null message from the second wireless device.

8. The method recited in claim 6, wherein the one or more electronic circuits remain in the low-power mode until a next polling period that is scheduled to start at a sniff anchor point following the scheduled sleep period.

9. The method recited in claim 1, wherein the first wireless device and the second wireless device are part of a piconet in which the first wireless device is a master device and the second wireless device is a slave device.

10. An apparatus, comprising:
a transmitter configured to transmit a poll message to a wireless device during a polling slot in a current polling period, the current polling period having multiple polling slots that are allocated to transmissions by the apparatus;
a receiver configured to receive, from the wireless device, a null message acknowledging the transmitted poll message; and
at least one processor configured to terminate the current polling period early in response to the current polling period having one or more remaining polling slots allocated to transmissions by the apparatus when the null message is received.

11. The apparatus recited in claim 10, wherein the transmitter is further configured to transmit, to the wireless device, an early termination message to indicate that the apparatus is terminating the current polling period early and no further transmissions from the apparatus are pending in the current polling period.

12. The apparatus recited in claim 11, wherein the early termination message comprises a command configured to cause the wireless device to place one or more electronic circuits into a low-power mode prior to a sleep period that is scheduled to start when the current polling period ends.

13. The apparatus recited in claim 11, wherein the receiver is further configured to receive, from the wireless device, capability information indicating whether the wireless device has an ability to terminate the current polling period early.

14. The apparatus recited in claim 13, wherein the transmitter is configured to transmit the early termination message to the wireless device in response to the received capability information indicating that the wireless device has the ability to terminate the current polling period early.

15. The apparatus recited in claim 10, wherein the at least one processor is further configured to place one or more electronic circuits into a low-power mode prior to a sleep period that is scheduled to start when the current polling period ends.

16. The apparatus recited in claim 15, wherein the one or more electronic circuits include a radio frequency transceiver into which the transmitter and the receiver are incorporated.

17. The apparatus recited in claim 15, wherein the one or more electronic circuits remain in the low-power mode until a next polling period that is scheduled to start at a sniff anchor point following the scheduled sleep period.

18. A method for reducing power consumption for wireless devices, comprising:
receiving, by a first wireless device, a poll message from a second wireless device during a polling slot in a current polling period, the current polling period having multiple polling slots that are allocated to transmissions by the second wireless device;
transmitting, by the first wireless device, a null message to the second wireless device, the null message acknowledging the poll message received from the second wireless device; and
terminating, by the first wireless device, the current polling period early in response to receiving an early termination message from the second wireless device while the current polling period has one or more remaining polling slots allocated to transmissions by the second wireless device.

19. The method recited in claim 18, wherein the early termination message indicates that the second wireless device is terminating the current polling period early and no further transmissions from the second wireless device are pending in the current polling period.

20. The method recited in claim 18, further comprising transmitting, to the second wireless device, capability information indicating that the first wireless device has an ability to terminate the current polling period early.

21. The method recited in claim 18, wherein terminating the current polling period early comprises placing one or more electronic circuits into a low-power mode prior to a sleep period that is scheduled to start when the current polling period ends.

22. The method recited in claim 21, wherein the one or more electronic circuits include a radio frequency transceiver configured to receive the poll message from the second wireless device and to transmit the null message to the second wireless device.

23. The method recited in claim 21, wherein the one or more electronic circuits remain in the low-power mode until a next polling period that is scheduled to start at a sniff anchor point following the scheduled sleep period.

24. The method recited in claim 18, wherein the first wireless device and the second wireless device are part of a piconet in which the first wireless device is a slave device and the second wireless device is a master device.

25. An apparatus, comprising:
a receiver configured to receive a poll message from a wireless device during a polling slot in a current polling period, the current polling period having multiple polling slots that are allocated to transmissions by the wireless device;
a transmitter configured to transmit a null message to the wireless device, the null message acknowledging the poll message received from the wireless device; and
at least one processor configured to terminate the current polling period early in response to an early termination message received from the wireless device while the current polling period has one or more remaining polling slots allocated to transmissions by the wireless device.

26. The apparatus recited in claim 25, wherein the early termination message indicates that the wireless device is terminating the current polling period early and no further transmissions from the wireless device are pending in the current polling period.

27. The apparatus recited in claim 25, wherein the transmitter is further configured to transmit, to the wireless device, capability information indicating that the apparatus has an ability to terminate the current polling period early.

28. The apparatus recited in claim 25, wherein the at least one processor is further configured to place one or more electronic circuits into a low-power mode prior to a sleep period that is scheduled to start when the current polling period ends.

29. The apparatus recited in claim 28, wherein the one or more electronic circuits include a radio frequency transceiver into which the transmitter and the receiver are incorporated.

30. The apparatus recited in claim 28, wherein the one or more electronic circuits remain in the low-power mode until a next polling period that is scheduled to start at a sniff anchor point following the scheduled sleep period.
